(19) United States
(12) Patent Application Publication
(10) Pub. No.: US 2008/0108302 A1
(43) Pub. Date: May 8, 2008

(54) Multi-radio mobile application

(76) Inventors: Mikko Linnamaki, Stuttgart (DE); Tero Katajainen, Helsinki (FI)

Correspondence Address: CARR & FERRELL LLP, 2200 GENG ROAD, PALO ALTO, CA, 94303, US

(21) Appl. No.: 11/594,305

(22) Filed: Nov. 7, 2006

(51) Int. Cl. H04H 20/00; H04M 1/00

(52) U.S. Cl. 455/3.06; 455/550.1

(57) ABSTRACT

Architecture for playing audio content multiple audio sources of different types is provided. A processor is configured to locate the audio sources of different types that are each associated with a network address, and transmit data identifying the audio sources of different types to the mobile device. The mobile device is configured to generate a display of the data identifying the pluarlity of audio sources of different types and a user interface allowing a user to select one of the audio sources, and receive a user selection of one of audio sources. The processor, upon receiving the user selection from the mobile device, is configured to transmit the network address of the desired audio source to the mobile device. The mobile device, upon receiving the network address of the desired audio source, is configured to play streaming audio data from the desired audio source.

### CROSS-REFERENCE TO RELATED APPLICATIONS

This application is related to U.S. patent application Ser. No. 11/______ filed ______, 2006 (Express Mail Label EV 826 333 245 US) and entitled “Interface for Selecting Audio-Video Sources in a Limited Display Environment,” the disclosure of which is incorporated herein by reference. The aforementioned application is commonly owned and assigned.

### BACKGROUND OF THE INVENTION

1. Field of the Invention

The present invention relates generally to the field of mobile devices and, in particular, to providing audio content to mobile devices.

2. Description of the Prior Art

As more people adopt mobile devices such as cellular telephones, service providers are seeking additional services and features to provide to customers to increase the average revenue per unit (ARPU). Some of these services include data communications such as short message service (SMS) for text messaging, email, packet switching for access to the Internet, and multimedia messaging service (MMS) for sending and receiving photos and video, and downloadable features such as games, ring-tones, songs, and video clips.

Using these services, however, can be awkward and/or expensive for a customer. A customer, who wishes to play music on a cellular phone, must navigate to a cellular provider's website, select a song, authorize a fee payment, download the song, and then play the song on the cellular phone. To listen to another song, the user must repeat the process. The customer is limited to purchasing the songs or programs provided by the cellular provider.

Using a personal computer, a person can access streaming media posted on the Internet such as streaming radio broadcasts. Further, a person can access personalized music services such as Pandora and Last.fm. Some of these types of audio sources are available for free. Additionally, content such as music on-demand and podcasts can be purchased and/or downloaded onto the personal computer. However, customers are unable to access this audio content using the services provided by mobile telephone providers and/or operators.

To be able to access these types of audio sources on a mobile device, the user must use a separate application for each type of audio data. For example, a user may have one application to access a personalized music service, a second application to access streaming radio broadcasts, and a third application to access podcasts. These applications each have a separate user interface that the mobile device user must learn to operate. Further, they must each be purchased and installed separately on the phone.

Additionally, the separate applications are problematic for mobile device operators. For example, each of these applications has separate connectivity requirements and so each of these applications must be tested by each operator for each mobile device before being able to communicate via the operator's network. Further, each application may have separate billing methods and schemes that are expensive for an operator to support. As such, operators are hesitant to adopt or approve new applications for their customers.

Hence, there is a need for a mobile application that simplifies accessing and playing audio content on a mobile device from multiple types of audio sources. Additionally, there is a need for an application that simplifies connectivity and billing methods associated with audio content.

### SUMMARY OF THE INVENTION

Embodiments of the present invention provide an architecture for accessing audio content from multiple audio sources of different types on a mobile device. A processor is configured to locate audio sources that are each associated with a network address, and transmit data identifying the audio sources to a mobile device. The mobile device is configured to generate a display of the data identifying the plurality of audio sources of different types and a user interface allowing a user to select one of the audio sources, and to transmit this selection to the processor. The processor, upon receiving the user selection from the mobile device, is configured to transmit the network address of the desired audio source to the mobile device. The mobile device, upon receiving the network address of the desired audio source, is configured to play audio data from the desired audio source.

Various embodiments of the invention and several alternatives are disclosed. A first embodiment of the present invention provides a system and a method for receiving radio content from multiple audio sources of different types on a mobile device. A second embodiment provides a system and method for providing radio content from multiple audio sources of different types to a mobile device. An exemplary embodiment consolidates processes for receiving different types of audio sources on a mobile device.

### BRIEF DESCRIPTION OF DRAWINGS

In the attached drawings:

FIG. 1 is a symbolic diagram of a network environment in which various embodiments of the present invention may be practiced;

FIG. 2 is a symbolic diagram showing the principal components of a mobile device according to various embodiments of the present invention;

FIG. 3 is a flowchart showing the major steps of receiving radio content from multiple audio sources on a mobile device according to various embodiments of the invention;

FIG. 4 is a flowchart showing the major steps of providing radio content from multiple audio sources to a mobile device according to various embodiments of the invention; and

FIG. 5 is a flowchart showing the major steps of processing a purchase authorization received from a mobile device according to various embodiments of the invention.

### DETAILED DESCRIPTION OF THE INVENTION

The present invention allows a user of a mobile device to access audio content from multiple audio sources of different types accessible via the Internet. The present invention provides an application that can be installed on a mobile device and servers for providing data used by the application to the mobile device. The application is configured to receive data identifying the audio sources from the servers and, based on a user selection, receive streaming audio or an audio download from the audio source. One of the servers is configured to locate the audio sources that are each associated with a network address, and transmit data identifying the audio sources to the mobile device.

The types of audio sources may comprise streaming radio broadcasts, personalized radio services, music-on-demand, single audio file downloads and/or podcasts. The audio content may be free or purchased by the mobile user. Visual content may be added to the audio content. The visual content may include interactive features such as voting and purchasing options. The mobile device application includes a substantially uniform user interface for the various types of audio content. The mobile device application further provides uniform connectivity requirements to access the multiple audio sources. Further, the application can manage various billing and payment methods according to exemplary embodiments.

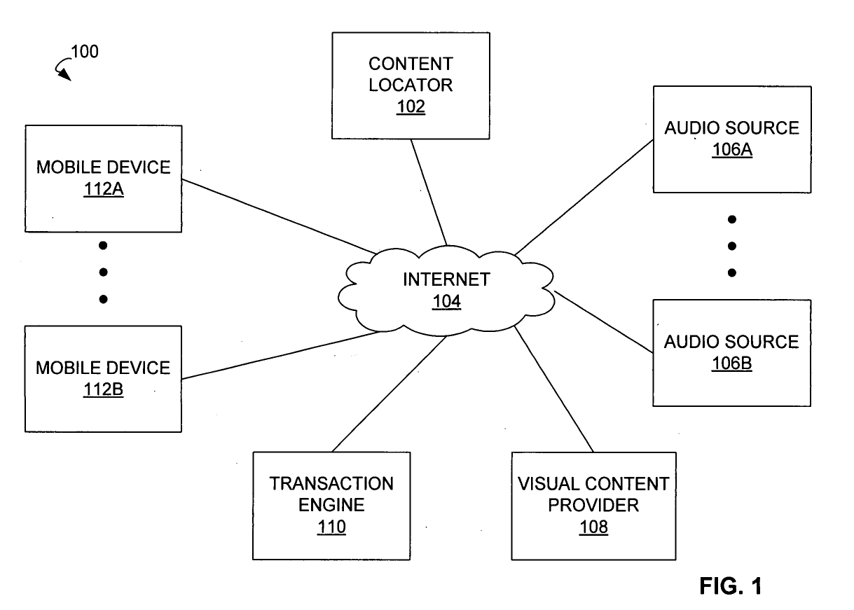

FIG. 1 is a symbolic diagram of a network environment 100 in which various embodiments of the present invention may be practiced. The network environment 100 comprises a content locator 102, audio sources 106, a visual content provider 108, a transaction engine 110, and mobile devices 112. These components are communicatively linked via the Internet 104.

In operation, the content locator 102 is configured to locate the audio sources 106 on the Internet 104. According to some embodiments, the content locator 102 comprises an Internet crawler engine that browses and indexes audio sources on the Internet. The content locator 102 may index audio sources according to type, genre, geographic location, language, and the like. The content locator 102 further stores a network address, such as a uniform resource locator (URL), associated with each audio source 106. The content locator 102 may also store audio content retrieved from the audio sources 106 that can be downloaded by the mobile devices 112. In an exemplary embodiment, the content locator 102 additionally compresses the audio content and/or converts the audio content to another data format.

The audio sources 106 may comprise audio sources of different types. Types of audio sources include live radio broadcast streams, personalized radio services, music on-demand providers, downloadable audio files, and podcast providers. Each audio source 106 is associated with a network address accessible via the Internet 104. Alternatively, the audio sources 106 may provide downloadable media that can be downloaded to the content locator 102 or directly to the mobile devices 112. In other embodiments, the audio source 106 may transmit a streaming radio broadcast or a personalized radio broadcast as streaming audio accompanied by sync data. The sync data may contain metadata associated with the streaming audio data such as a song title, artist, studio, release date, or the like.

In some embodiments, the visual content provider 108 is configured to use the sync data transmitted by the audio sources 106 to generate a visual display to accompany the audio stream on the mobile devices 112, which may include content collected from the Internet 104 about the song or artist. The visual and interactive information may be associated with, for example, shopping sites, social networks, and other content providers. For example, the visual content provider 108 may collect information such as music recommendations relating to the current song from a social network to which the user belongs. For example, if the sync data associated with audio source 106A indicates that the song “Like a Prayer” by Madonna is playing, the visual content provider 108 may aggregate information or data from the Internet about images, news stories, discography, and the like relating to Madonna.

The visual content provider 108 may further aggregate advertisements and/or other unrelated media. The visual content provider 108 may have previously collected the information or data. Alternatively or additionally, the visual content provider 108 will fetch the information or data when the sync data is received. The visual content provider 108 transmits the visual display to the mobile device 112.

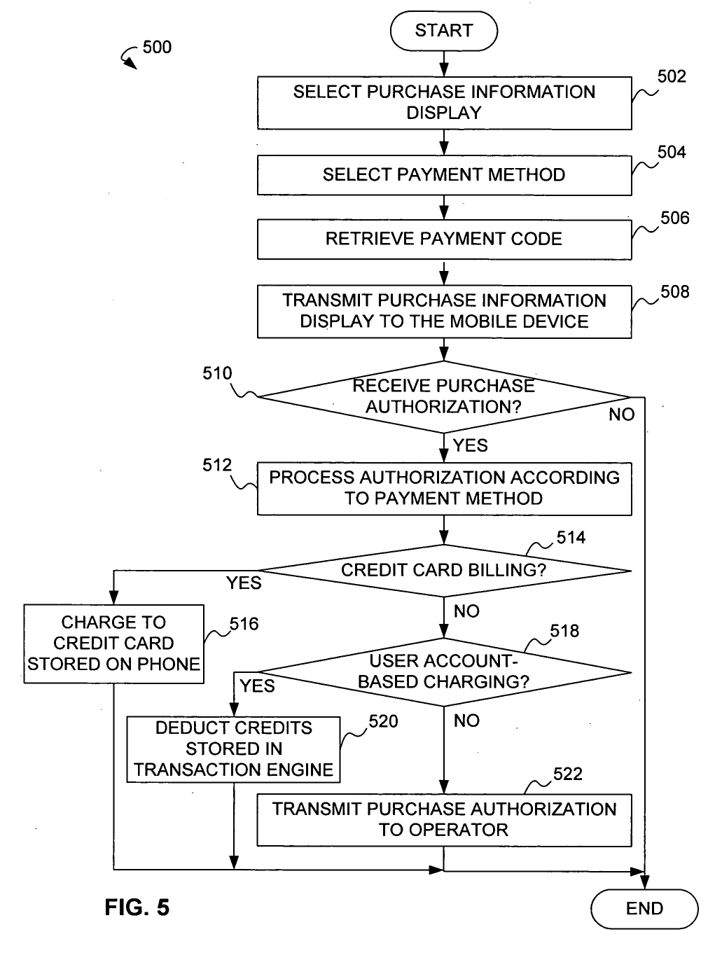

The visual content provider 108 may be configured to add interactive elements to the visual content displayed on the mobile devices 112. The visual content provider 108 may add an option to rank or vote for a song. In other embodiments, a transaction engine 110, in conjunction with the visual content provider 108, adds an option to make a purchase using the mobile device 112. The transaction engine 110 may, for example, generate and transmit a purchase information display indicating an option to purchase a podcast subscription, song ring-tone, concert tickets, or the like to the mobile device 112. The transaction engine 110 may be configured to process the transactions using multiple billing methods as discussed in connection with FIG. 5.

The mobile device 112 may comprise a mobile telephone, cellular telephone, personal digital assistant (PDA), or the like. The mobile device 112 is at least configured to receive data identifying the audio sources 106 from the content locator 102, and, based on a user selection, audio data from the content locator 102 or the audio sources 106. In other embodiments, the mobile device 112 is configured to receive and process visual data and interactive data from the visual content provider 108 to generate a display accompanying the audio data. The visual display may comprise a series of images, an interactive menu, and/or interactive features such as voting and/or purchase information displays.

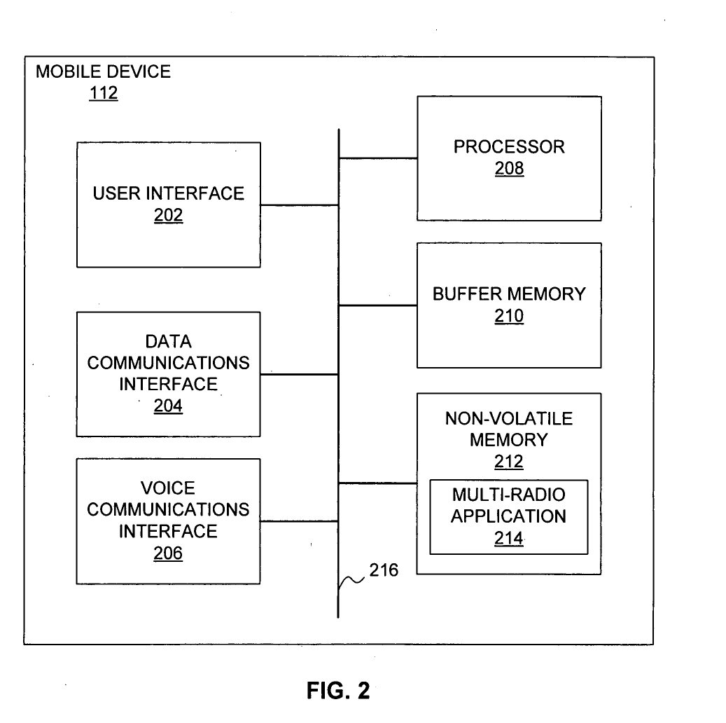

FIG. 2 is a symbolic diagram showing the principal components of a mobile device 112 according to an embodiment of the present invention. The mobile device 112 comprises a user interface 202, a data communications interface 204, a voice communications interface 206, a processor 208, a buffer memory 210, and a non-volatile memory 212 connected by a bus 216.

The user interface 202 enables the user to interact with the mobile device 112 and may comprise a display, a speaker, a keypad, and a microphone. The data communications interface 204 is configured to transmit and receive data using third generation wireless (3G) technology, a wireless local area network (WLAN) such as a wireless fidelity (WiFi)-compatible network, or other wireless data communications network. The voice communications interface 206 is configured to communicate over a cellular or other voice communications network for voice calling. The processor 208 is configured to execute instructions stored in the buffer memory 210 and the non-volatile memory 212. The buffer memory 210 comprises a re-writeable memory such as random access memory (RAM) or Flash memory. The non-volatile memory 212 may comprise read-only memory (ROM) and/or Flash memory.

The multi-radio application 214, as discussed herein, is stored in the non-volatile memory 212. The multi-radio application 214 is a program executable by the processor 208 to receive audio content on the mobile device 112. In some embodiments, the multi-radio application 214 is updatable by the content locator 102, the visual content provider 108, and/or the transaction engine 110. The multi-radio application 214 may direct the processor 208 to store streaming audio and/or visual data in the buffer memory 210. Audio downloads, such as podcasts and/or music on-demand may be stored in the non-volatile memory 212.

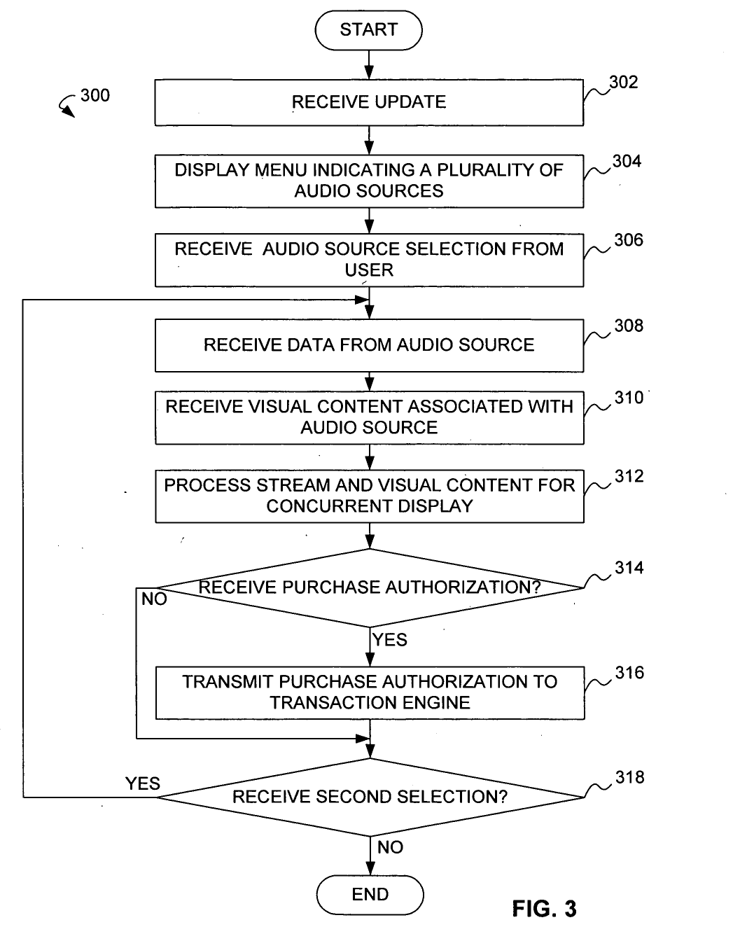

FIG. 3 is a flowchart showing the major steps of a process 300 for receiving audio content from multiple audio sources 106 on a mobile device 112 according to one embodiment of the invention. The process 300 is performed when the processor 208 executes the multi-radio application 214.

In step 302, the mobile device 112 receives an update from the content locator 102 and/or the visual content provider 108. The update may comprise a software update and/or graphical user interface content. The update may additionally comprise data identifying the audio sources 106 such as type, name, logo, genre, geographical location, and/or network address. The audio sources 106 may be listed in an audio source selection menu.

In step 304, the mobile application generates a display of the data identifying the audio sources 106 and a user interface allowing a user to select one of the audio sources 106. The menu may comprise a list predefined audio sources by default. In some embodiments, the user interface comprises a directory in which a user may enter search criteria for audio sources. The search criteria may include genre, artists, song titles, geographic location, language, and the like. For example, a user may search for radio broadcast streams in Sweden in the “Blues” genre. The menu will then list audio sources 106 from Sweden that play the Blues.

In some embodiments, audio data including music on-demand or a single audio file download may be available for purchase. The user may search for or select a program such as a song, music video, album, or concert recording to stream to the mobile device 112. For example, a single audio file download can be a “Track of the Day.” A request for purchased content may initiate a transaction that is processed by the transaction engine 110.

In step 306, the mobile device 112 receives an audio source selection from the user indicating a desired audio source 106 and transmits the selection to the content locator 102 and/or the visual content provider 108. In embodiments comprising a personalized radio service, the audio source selection may further indicate an artist or other preference received from the user.

In step 308, the mobile device 112 accesses the audio source 106 using the network address associated with the audio source 106 and receives audio data from the audio source 106. The audio source 106 may stream audio data directly to the mobile device 112. Alternatively, the audio data may be downloaded as a podcast, single audio file or music on-demand. The audio data is typically streaming audio data or one or more audio files. In some embodiments, the audio data may be received from the content locator 102 and/or the visual content provider 108 rather than an audio source 106.

In some embodiments, the mobile device 112 receives visual content from the visual content provider 108 in step 310. The visual content may comprise advertisements and/or content associated with the audio source 106, and may include interactive features such as a menu, or purchase information displays associated with goods or services. The interactive features may also include messages or selections such as SMS and/or MMS messaging, freeform text input, and rating, voting, quiz, or survey answers.

In step 312, the mobile device 112 processes the audio stream and the visual content to play the audio data concurrently with the visual data. For example, if a song by Madonna is playing, pictures of Madonna may be shown. In interactive embodiments, a menu may appear allowing a user to view pictures, a tour schedule, Madonna's discography, and the like. An option to vote on an issue such as whether Madonna should release another album may be available. In some embodiments, a purchase information display depicting Madonna concert tickets, Madonna ring-tones, Madonna wallpaper, downloads of Madonna songs, and the like may appear.

In step 314, a purchase authorization may be received from the user of mobile device 112. If a purchase authorization is received, the authorization is transmitted to the transaction engine 110 in step 316. The transaction engine 110 will process the transaction to select and process a payment method. After a transaction is processed, the visual content may be updated with a new menu seeking additional information, a results page, or a purchase confirmation page.

If a second user selection of an audio source 106 is received from the user in step 318, the process 300 returns to step 308. If no second selection is received from the user, the mobile device 112 continues to receive and process the audio data and visual data associated with the audio source 106 selected by the user in step 306 until the user terminates the session or the presentation of a particular song or file ends.

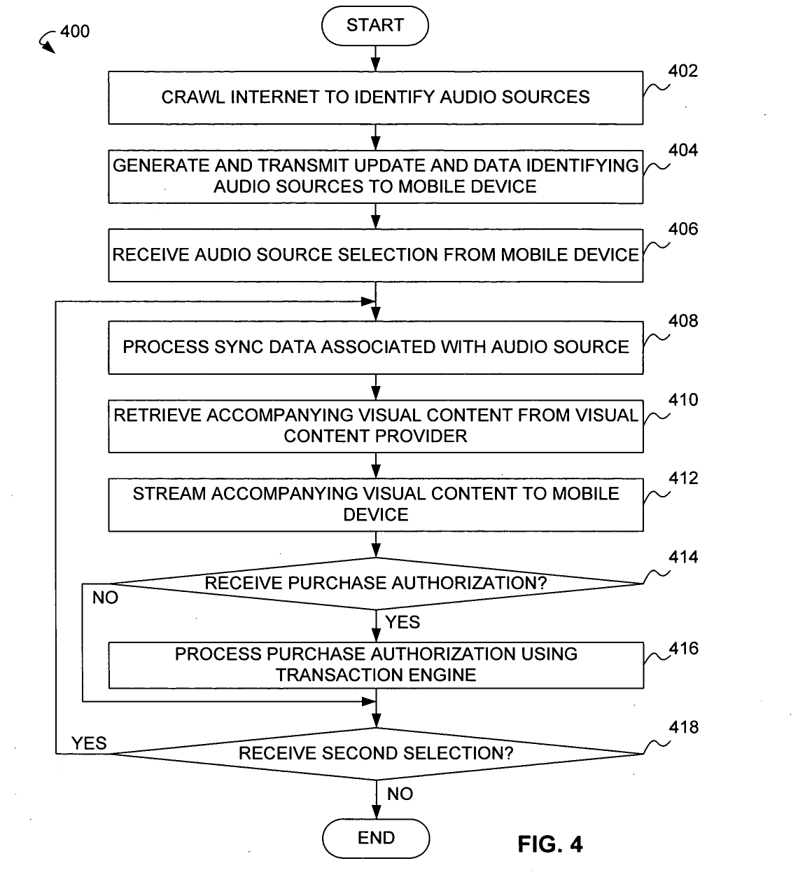

FIG. 4 is a flowchart showing the major steps of a process 400 for providing radio content from multiple audio sources 106 of different types to a mobile device 112 according to embodiments of the invention. The process 400 can be performed, for example, by the content locator 102 and the visual content provider 108.

In step 402, the content locator 102 crawls the Internet 104 to identify audio sources such as audio sources 106A and 106B in FIG. 1. The content locator 102 may index the audio sources 106 according to type, genre, geographic location, language, URL, and the like. The types of audio sources 106 may include streaming radio broadcasts, personalized radio services, podcasts, single audio files and/or music on-demand. The content locator 102 may optionally identify audio sources 106 to list in a predefined audio source set loaded to the application. For example, the predefined audio source set may include popular streaming radio broadcasts. Alternatively, the predefined audio source set may be identified as a list personalized for the user of the mobile device 112 as a “favorites” menu.

In step 404, the content locator 102 generates and transmits an application update and/or data identifying the audio sources 106 to the mobile device. The data may include identification of the set of predefined audio sources. The data identifying the audio sources 106 may also comprise an interface allowing a user to provide search terms.

In step 406, the content locator 102 or the visual content provider 108 receives an audio source selection from the mobile device 112. In some embodiments, the content locator 102 does not send the network address of the desired audio source 106 until the user has selected the audio source 106. The content locator 102 may receive the audio source selection by name, in the form of search terms, as an indication of a source listed in a directory, or in some other form. If the audio source selection indicates more than one audio source 106 from a directory or the search terms match more than one audio source 106, the content locator 102 will provide a list of results to the mobile device 112 including the URLs of the audio sources 106. The user can then make a second audio source selection indicating a single audio source 106 from the list.

In the illustrated embodiment, the visual content provider 108, upon receiving a user selection from the mobile device 112 in step 406, processes sync data from the selected audio source 106 in step 408. The sync data may indicate the song or program currently being transmitted by the audio source 106. In step 410, the visual content provider 108 may aggregate content such as advertisements, images, quizzes, polls, purchase information displays, biographical profiles of the artists, song lyrics, and artist discography from the Internet 104, telephone service provider, media provider, or the like. The visual content provider 108 can select and sequence the content into a visual display that can be displayed concurrently with the song or other program on the mobile device 112. In step 412, the visual content provider 108 streams the visual display to the mobile device 112.

If the visual display includes a purchase information display, the visual content provider 108 may receive a purchase authorization from the mobile device 112 in step 414. If a purchase authorization is received, the authorization is processed using the transaction engine 110 in step 416. In step 418, a second selection of an audio source 106 may be received. If a second selection is received, the process 400 returns to step 408. Otherwise, if no second selection is received, the visual content provider 108 and/or the transaction engine 110 continues to provide visual data to the mobile device 112 until the user terminates the session or the presentation of a particular song or file ends.

FIG. 5 is a flowchart showing the major steps of a process 500 for processing a purchase authorization received from a mobile device 112 according to an embodiment of the invention. The process 500 provides a common billing scheme for the mobile devices for various types of transactions. The process 500 may be performed by the transaction engine 110.

In step 502, the visual content provider 108 and/or the transaction engine 110 select one or more purchase information displays to transmit to the mobile device 112. The purchase information display indicates an item available for purchase and may further include a price, vendor, and/or payment method. The selection may be based on the sync data associated with a selected audio source 106.

In step 504, a payment method is selected for something that is being sold using the multi-radio application 214. The payment methods may include such forms as: premium short message service (SMS), wireless application protocol (WAP) billing, credit card billing, and/or user account-based billing. The payment method may be selected based on the price of what is being sold. For example, a ring-tone having a price of $1.00 may be billed using a premium SMS or WAP billing, while a concert ticket having a price of $22.00 may be billed to a credit card stored on the mobile device 112. The selection may also be based on the country and telephone operator.

In step 506, if needed, a payment code is retrieved from the seller or a stored table listing possible transactions that can be transmitted to the mobile device 112. The payment code may indicate a vendor, payee, and/or a type of payment. In some embodiments, the payment code may also comprise a telephone number for premium SMS billing or a URL for WAP billing.

In step 508, the visual content provider 108 transmits the purchase information display to the mobile device 112. The purchase information display may include a visual display of something that is being purchased, a menu for the user to specify a particular preference, and/or a catalogue of possible purchase items such as a list of albums by a specific artist or collections relating to a musical genre. For example, a concert ticket purchase information display may include a menu for the user to specify a preference such as location, date, and/or seating preference. The purchase information display may also include an indication of the payment method. In some embodiments, the purchase information display may comprise an interface allowing the user to execute a payment using the selected method.

In step 510, a purchase authorization may be received from the mobile device 112. If a purchase authorization is received, the transaction engine 110 processes the authorization according to the selected payment method in step 512. For example, in step 514, if the payment method is credit card billing, the price is charged to a credit card number stored on the mobile device 112 in step 516. If the payment method is user account-based charging in step 518, the transaction engine 110 deducts credits stored in the transaction engine 110 associated with the mobile device 112 in step 520. In step 522, if WAP billing or premium SMS is selected, the purchase authorization is transmitted to the operator according to the payment code retrieved in step 506. In some embodiments, other billing methods, such as a Paypal® account billing method may be incorporated into the process 500.

The invention is not limited to the applications listed above. The present invention can also be applied in many other fields such as inspection, assembly, and logistics. It will be recognized that this list is intended as illustrative rather than limiting and the invention can be utilized for varied purposes.

The present invention provides a system and method for accessing audio content from multiple sources using a mobile device. “Mobile device” as used herein, comprises a mobile telephone, personal digital assistant, personal music player such as a portable MP3 player, or the like.

In the foregoing specification, the present invention is described with reference to specific embodiments thereof, but those skilled in the art will recognize that the present invention is not limited thereto. Various features and aspects of the above-described present invention may be used individually or jointly. Further, the present invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A mobile communication device for receiving streaming audio content comprising:
a data communications interface configured to receive data from a server, the data identifying audio streams available from a plurality of audio sources of different types accessible via the Internet, and to receive streaming audio data from a selected audio source; and
a processor configured to display data identifying the plurality of audio sources of different types and a user interface allowing a user to select one of the audio sources, receive the user selection of one of the audio sources, and play the streaming audio data associated with the selected audio source.

2. The system of claim 1, wherein the data communications interface is further configured to receive visual data associated with the streaming audio data and the processor is further configured to generate another display containing the visual data and associated with the streaming audio data.

3. The system of claim 2, wherein the user interface allows the user to enter additional information.

4. The system of claim 3, wherein the additional information comprises a message from the user.

5. The system of claim 3, wherein the additional information comprises a selection from the user.

6. The system of claim 3, wherein the additional information comprises a purchase authorization.

7. The system of claim 6, wherein the user interface displays a billing method selected from the group consisting of: premium SMS, WAP billing, credit card billing, user account-based billing, and Paypal® account billing.

8. The system of claim 1, wherein at least one of the different types of the plurality of audio sources comprises a streaming radio broadcast server.

9. The system of claim 1, wherein at least one of the different types of the plurality of audio sources comprises an on-demand music provider.

10. The system of claim 1, wherein at least one of the different types of the plurality of audio sources comprises a podcast provider.

11. The system of claim 1, wherein at least one of the different types of the plurality of audio sources comprises a personalized radio provider.

12. The system of claim 1, wherein at least one of the different types of the plurality of audio sources comprises a single audio file download.

13. The system of claim 1, wherein the display of the data comprises a menu indicating predefined audio source set.

14. A method for receiving audio content comprising:
receiving data from a server, the data identifying audio streams available from a plurality of audio sources of different types accessible via the Internet;
displaying the data identifying the plurality of audio sources of different types and a user interface allowing the user to select one of the audio sources;
receiving a user selection of one of the plurality of audio sources of different types;
based on the user selection, receiving streaming audio data a selected audio source; and
playing the streaming audio data associated with the selected audio source.

15. The method of claim 14, wherein the method further comprises receiving visual data associated with the streaming audio data and accompanying the streaming audio data with the visual data.

16. The method of claim 15, wherein the method further comprises generating another user interface from the visual data that allows a user to authorize a purchase.

17. The method of claim 14, wherein at least one of the different types of the plurality of audio sources comprises a streaming radio broadcast server.

18. A computer readable medium having embodied thereon a program, the program being executable by a processor to perform a method for receiving audio content on a mobile device, the method comprising:
receiving data from a server, the data identifying audio streams from a plurality of audio sources of different types accessible via the Internet;
displaying the data identifying the plurality of audio sources of different types and a user interface allowing the user to select one of the audio sources;
receiving a user selection of one of the plurality of audio sources of different types;
based on the user selection, receiving streaming audio data via the Internet; and
playing the streaming audio data associated with the selected audio source.

19. A method for providing audio content to a mobile device, the method comprising:
locating a plurality of audio sources of different types on the Internet, each associated with a network address;
transmitting data identifying the plurality of audio sources of different types to the mobile device;
receiving a user selection indicating a desired audio source; and
transmitting the network address associated with the desired audio source to the mobile device.

20. The method of claim 19, further comprising:
storing audio data associated with a first audio source of the plurality of the audio sources of different types;
receiving a user selection indicating the first audio source; and
transmitting the audio data associated with the first audio source to the mobile device.

21. The method of claim 19, further comprising transmitting visual data to the mobile device according to sync data associated with the desired audio source.

22. The method of claim 21, wherein the visual data comprises a user interface that allows a user to enter additional information.

23. The method of claim 22, wherein the additional information comprises a selection from the user.

24. The method of claim 22, wherein the additional information comprises a purchase authorization.

25. The method of claim 24, further comprising selecting a billing method from the group consisting of but not limited to: premium SMS, WAP billing, credit card billing, user account-based billing, and Paypal® account billing.

26. The method of claim 19, wherein at least one of the different types of the plurality of audio sources comprises an on-demand music provider.

27. The method of claim 19, wherein at least one of the different types of the plurality of audio sources comprises a podcast provider.

28. A system for providing audio content to a mobile device, the system comprising:
a processor configured to locate audio sources of different types on the Internet, each audio source associated with a network address; and
a data communications interface configured to transmit data identifying the audio sources of different types to the mobile device, receive a user selection indicating a desired audio source, and transmit the network address associated with the desired audio source to the mobile device.

29. The system of claim 28, wherein the processor is further configured to transmit visual data to the mobile device according to sync data associated with the selected audio source.

30. The system of claim 29, wherein the visual data comprises a user interface that allows a user to enter additional information.

31. The system of claim 30, wherein the additional information comprises a purchase authorization and the processor is further configured to select a billing method from the group consisting of: premium SMS, WAP billing, credit card billing, user account-based billing, and Paypal® account billing.

32. The system of claim 28, wherein at least one of the different types of the audio sources comprises a streaming radio broadcast server.

33. The system of claim 28, wherein at least one of the different types of the audio sources comprises a personalized radio server.
